(19) United States
(12) Patent Application Publication
(10) Pub. No.: US 2014/0320438 A1
(43) Pub. Date: Oct. 30, 2014

(54) DISPLAY DEVICE INCLUDING TOUCH PANEL AND METHOD OF EVALUATING VISIBILITY OF ELECTRODE PATTERN OF TOUCH PANEL

(71) Applicant: SAMSUNG ELECTRO-MECHANICS CO., LTD., Suwon-Si (KR)

(72) Inventors: Victor YURLOV, Suwon-Si (KR); Sang Su HONG, Suwon-Si (KR); Hee Soo KIM, Suwon-Si (KR); June Sik PARK, Suwon-Si (KR); Seung Woo KIM, Suwon-Si (KR); Hyun KIM, Suwon-Si (KR)

(73) Assignee: SAMSUNG ELECTRO-MECHANICS CO., LTD., Suwon-Si (KR)

(21) Appl. No.: 14/263,907

(22) Filed: Apr. 28, 2014

(30) Foreign Application Priority Data
Apr. 30, 2013 (KR) 10-2013-0048574

(51) Int. Cl. G06F 3/041

(52) U.S. Cl. CPC G06F 3/041
USPC 345/173

(57) ABSTRACT

Disclosed herein is a display device including a touch panel, including: a transparent substrate; an electrode pattern formed as a mesh pattern on the transparent substrate; and a display unit correspondingly coupled to the electrode pattern, wherein a ratio of a pitch of the electrode pattern to a pitch of a pixel of the display unit is 1:0.3 to 1:0.5. Therefore, the Moire phenomenon that may be generated between the electrode pattern of the touch panel and the pixel pattern of the display unit coupled to the touch panel may be prevented.

### CROSS REFERENCE TO RELATED APPLICATION

This application claims the benefit of Korean Patent Application No. 10-2013-0048574, filed on Apr. 30, 2013, entitled “Display Device Including Touch Panel and Method for Evaluation Visibility of Electrode Pattern of the Touch Panel”, which is hereby incorporated by reference in its entirety into this application.

### BACKGROUND OF THE INVENTION

1. Technical Field

The present invention relates to a display device including a touch panel and a method of evaluating visibility of an electrode pattern of the touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

In accordance with the rapid advancement of an information-oriented society, the use of computers has gradually been widened; however, it is difficult to efficiently operate products using only a keyboard and a mouse currently serving as an input device. Therefore, the necessity for a device that is simple, has less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of a display such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the display.

In addition, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, in the touch panel, research into a technology of forming an electrode pattern using a metal has been actively conducted, as disclosed in the following Prior Art Document (Patent Document). As described above, when the electrode pattern is made of the metal, electric conductivity is excellent and demand and supply is smooth. However, in the case in which the electrode pattern is made of the metal, there was a problem that the electrode pattern may be visible to the user.

### PRIOR ART DOCUMENT

### Patent Document

(Patent Document 1) JP2011-175967 A

### SUMMARY OF THE INVENTION

The present invention has been made in an effort to provide a display device including a touch panel and having calculated values of a pitch and an angle of a mesh pattern capable of preventing a Moire phenomenon between an electrode pattern formed as the mesh pattern of the touch panel and a pitch of a pixel of a display unit, and a method of evaluating visibility of an electrode pattern of the touch panel.

According to a first preferred embodiment of the present invention, there is provided a display device including a touch panel, including: a transparent substrate; an electrode pattern formed as a mesh pattern on the transparent substrate; and a display unit correspondingly coupled to the electrode pattern, wherein a ratio of a pitch of the electrode pattern to a pitch of a pixel of the display unit is 1:0.3 to 1:0.5.

An angle value of the electrode pattern may be in the range of 15 to 21 degrees.

The electrode pattern may be made of copper (Cu), aluminum (Al), gold (Au), silver (Ag), titanium (Ti), palladium (Pd), chromium (Cr), nickel (Ni), or a combination thereof.

The display unit may be any one of a liquid crystal display (LCD), a light emitting diode (LED), an organic light emitting diode (OLED), and a cathode ray tube (CRT).

According to another preferred embodiment of the present invention, there is provided a display device including a touch panel, including: a transparent substrate; an electrode pattern formed as a mesh pattern on the transparent substrate; and a display unit correspondingly coupled to the electrode pattern, wherein a ratio of a pitch of the electrode pattern to a pitch of a pixel of the display unit is 1:0.4 to 1:0.7.

An angle value of the electrode pattern may be in the range of 32 to 38 degrees.

The electrode pattern may be made of copper (Cu), aluminum (Al), gold (Au), silver (Ag), titanium (Ti), palladium (Pd), chromium (Cr), nickel (Ni), or a combination thereof.

The display unit may be any one of an LCD, an LED, an OLED, and a CRT.

An angle value of the electrode pattern may be in the range of 52 to 58 degrees.

According to still another preferred embodiment of the present invention, there is provided a method of evaluating visibility of an electrode pattern of a touch panel, including: storing an image overlapped between a mesh shaped electrode pattern formed in the touch panel and a pixel pattern of a display unit; converting the stored image data into a frequency data; filtering the frequency data using a contrast sensitivity function (CSF); performing frequency-inverse-conversion on the filtered frequency data to generate image data; calculating a standard deviation (STD) for the image data generated by the frequency-inverse-conversion; and judging whether or not the STD value satisfies the following Equation: STD(min)<STD<STD(min)×1.2 to adopt an electrode pattern formed in this region range.

The CSF may be represented by the following Equation:

CSF(ξ,η)=1.33 L\sqrt{ξ²+η²} exp(−0.49 L\sqrt{ξ²+η²})

where ξ and η mean spatial angular frequencies in X and Y axis direction in a two-dimension, respectively, and L means a distance of a field of view.

In the calculating of the STD, the STD may be defined as a root-mean square (RMS) appearing in the filtered image data:

$$RMS = \sqrt{\frac{1}{N - 1} {\sum }_{n}^{N} {( {I}_{n} - \overline{I} )}^{2}} \qquad ( Equation 1 )$$

where N indicates the number of respective discrete points of the image, In indicates an intensity level of an n-th point of the image, and Ī in the above Equation 1 is defined by the following Equation:

$$\overline{I} = \frac{1}{N} {\sum }_{n}^{N} {I}_{n} \qquad ( Equation 2 )$$

the above Equation 2 means intensity of the entire image.

The above Equation 1 for the STD may be represented by the following Equation:

$$σ = \sqrt{{\sum }_{n} {\sum }_{m} {\sum }_{k} {\sum }_{q} {\vert {A}_{n} \vert}^{2} {\vert {A}_{m} \vert}^{2} {\vert {X}_{k} \vert}^{2} {\vert {Y}_{4} \vert}^{2} {CSF}^{2} \{ \sqrt{{[ {Ω}_{n , m}^{X} + \frac{2 π}{{P}_{X}} k ]}^{2} + {[ {Ω}_{n , m}^{Y} + \frac{2 π}{{P}_{Y}} q ]}^{2}} \}} .$$

The converting of the stored image data into the frequency data and the performing of the frequency-inverse-conversion on the filtered frequency data to generate the image data may be performed by the Fourier transform and the inverse Fourier transform, respectively.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are views showing pitches of an electrode of a mesh pattern and a pixel of a display unit according to a preferred embodiment of the present invention;

FIG. 3 is a cross-sectional view of a touch panel according to a preferred embodiment of the present invention in which an electrode pattern is formed;

FIG. 4 is a cross-sectional view of a touch panel according to another preferred embodiment of the present invention in which electrode patterns are formed;

FIG. 5 is a cross-sectional view of a display device including the touch panel according to the preferred embodiment of the present invention;

FIG. 6 is a view showing a relationship between a spatial frequency depending on a human visible system and an identification capability depending on a contrast;

FIG. 7 is a view showing a combination pattern of an electrode pattern of a touch panel according to a first preferred embodiment of the present invention and a pixel pattern of a display unit;

FIG. 8 is a view showing a combination pattern of an electrode pattern of a touch panel according to a second preferred embodiment of the present invention and a pixel pattern of a display unit;

FIG. 9 is a view showing a combination pattern of an electrode pattern of a touch panel according to a third preferred embodiment of the present invention and a pixel pattern of a display unit; and

FIG. 10 is a flow chart showing a process of a method of evaluating visibility of an electrode pattern of the touch panel according to the preferred embodiment of the present invention

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

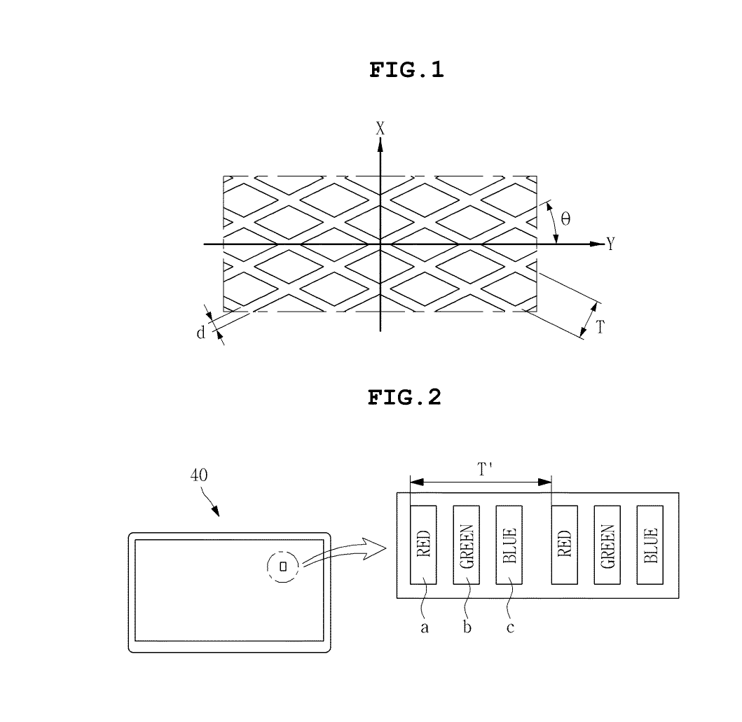

FIGS. 1 and 2 are views shown in order to define a pitch of a mesh pattern forming an electrode pattern 20 and a pitch T′ of a pixel of a display unit 40 coupled to a touch panel according to a preferred embodiment of the present invention.

A pitch T and an angle θ of the mesh pattern forming the electrode pattern 20 used in the present invention and the pitch T′ of the pixel of the display unit 40 may be defined as shown in FIGS. 1 and 2. That is, the pitch T of the mesh pattern may be represented by an interval T at which the mesh patterns are formed, and the angle thereof may be defined as an angle θ formed by the mesh patterns and a line Y horizontally connecting the mesh patterns to each other. A width d of the mesh pattern is defined as a specific constant value rather than a variable in the present invention. For example, the mesh pattern may be formed to have a width of about 5 μm. As the width d of the mesh pattern becomes wider, the electrode pattern is visibly better, and the width d of the mesh pattern may be appropriately changed depending on specifications of the touch panel.

The pitch T′ of the pixel of the display unit 40 will be defined. In the case of a liquid crystal display (LCD), the pitch T′ of the pixel of the display unit 40 means an interval between sub-pixels having the same color in a structure in which sub-pixels of R(a), G(b), and B(c) are horizontally arranged repeatedly.

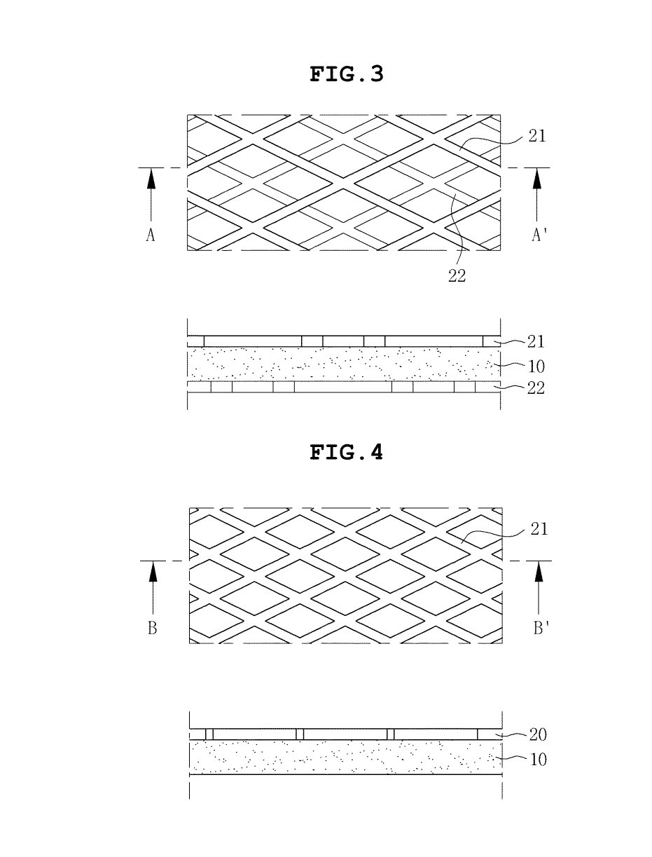

Further, in the present invention, the electrode pattern 20 may be applied to a structure in which first and second electrode patterns 21 and 22 are formed on both surfaces of a transparent substrate 10, respectively, as shown in FIG. 4 as well as a structure in which a single-layer electrode pattern 20 is formed on a transparent substrate 10 as shown in FIG. 3. Here, the electrode pattern 20 is formed as the mesh pattern having a predetermined pitch and angle as shown in FIGS. 3 and 4.

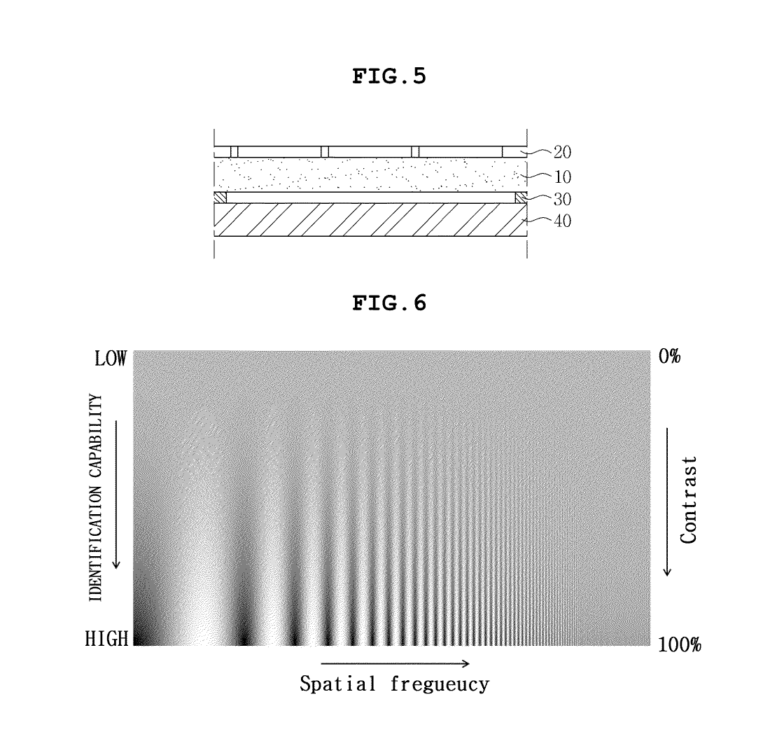

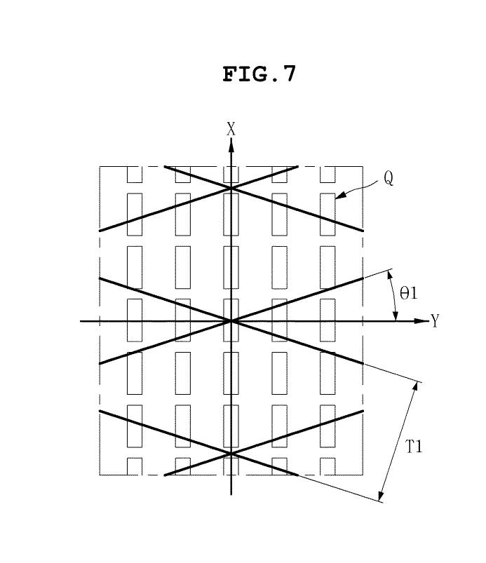

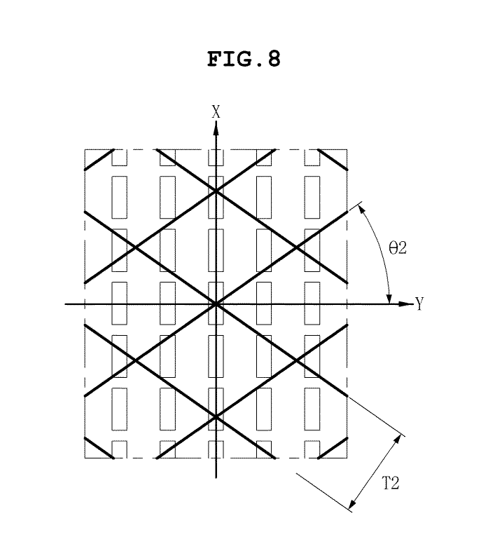

FIG. 5 is a view showing a relationship between a spatial frequency depending on a human visible system and an identification capability depending on a contrast; FIG. 6 is a view showing a combination image of an electrode pattern 20 of a touch panel according to a first preferred embodiment of the present invention and a pixel pattern of a display unit 40; FIG. 7 is a view showing a combination image of an electrode pattern 20 of a touch panel according to a second preferred embodiment of the present invention and a pixel pattern of a display unit 40; and FIG. 8 is a view showing a combination image of an electrode pattern 20 of a touch panel according to a third preferred embodiment of the present invention and a pixel pattern of a display unit 40.

The display device including the touch panel according to the preferred embodiment of the present invention is configured to include a transparent substrate 10, an electrode pattern 20 formed as a mesh pattern on the transparent substrate 10, and a display unit 40 correspondingly coupled to the electrode pattern 20, as shown in FIG. 5, wherein a ratio of a pitch T of the electrode pattern 20 to a pitch T′ of a pixel of the display unit 40 is 1:0.3 to 1:0.5.

The transparent substrate 10 may be made of any material having predetermined strength or more. For example, the transparent substrate 10 may be made of polyethylene terephthalate (PET), polycarbonate (PC), poly methyl methacrylate (PMMA), polyethylene naphthalate (PEN), polyethersulfone (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass, but is not necessarily limited thereto. In addition, since a transparent electrode may be formed on one surface of the transparent substrate 10, high frequency treatment, primer treatment, or the like, may be performed on one surface of the transparent substrate 10 to form a surface treatment layer.

In the present invention, the electrode pattern 20 is formed on the transparent substrate 10 and is formed as the mesh pattern. The mesh pattern is defined as a pitch value T and an angle value θ for specifying a shape of the mesh pattern. Particularly, since a decrease of the Moire generated due to an image of the electrode pattern 20 overlapped with the pitch T′ of the pixel of the display unit 40 should be considered, a ratio of the pitch of the electrode pattern 20 and the pitch T′ of the pixel of the display unit 40 may also be considered.

In addition, a method of evaluating a decreasing visibility of the electrode pattern 20 and a point at which the Moire phenomenon is minimized by specifying shapes of the mesh pattern forming the electrode pattern 20 and the pixel pattern of the display unit 40 is performed by the method of evaluating visibility of an electrode pattern 20 of a touch panel according to the preferred embodiment of the present invention, which will be described below.

The electrode pattern 20 serves to generate a signal by an input unit of a touch to allow a touch coordinate to be recognized from a controlling unit (not shown). In the present invention, the electrode pattern 20 may be formed as the mesh pattern as shown in FIG. 1, and a form of the mesh pattern may be defined as the pitch T and the angle value θ. A width d of the mesh pattern may be in the range defined by a general forming technology. The narrower the width d of the mesh pattern, the lower the visibility. Therefore, visibility characteristics of the electrode pattern 20 may be evaluated by the pitch T of the mesh pattern, the pitch T′ of the pixel of the display unit 40, and the angle value θ, which are main components related to the visibility and the generation of the Moire phenomenon in the mesh pattern, which are particularly problematic.

The electrode patterns 20 may be formed in a mesh pattern using copper (Cu), aluminum (Al), gold (Au), silver (Ag), titanium (Ti), palladium (Pd), chromium (Cr), or a combination thereof. Particularly, the mesh pattern may be formed by continuously arranging at least one unit pattern 20a.

The electrode patterns 20 may also be made of metal silver formed by exposing/developing a silver salt emulsion layer, a metal oxide such as an indium thin oxide (ITO), or the like, a conductive polymer such as poly-3,4-ethylenedioxythiophene/polystyrenesulfonate (PEDOT/PSS), or the like, having excellent flexibility and a simple coating process, in addition to the above-mentioned metal.

The electrode pattern may be formed by a dry process, a wet process, or a direct patterning process. Here, the dry process may include a sputtering process, an evaporation process, or the like, the wet process may include a dip coating process, a spin coating process, a roll coating process, a spray coating process, or the like, and the direct patterning process may include a screen printing process, a gravure printing process, an inkjet printing process, or the like.

More specifically, as shown in FIG. 7, an electrode pattern 20 according to a first preferred embodiment of the present invention may be formed so that a ratio of a pitch T1 of the mesh pattern to a pitch T′ of a pixel of the display unit 40 is 1:0.3 to 1:0.5. In this case, it is appropriate that an angle value θ1 of the mesh pattern is in the range of 15 to 21 degrees. The mesh pattern is designed so as to have the relative ratio of the pitch T1 of the mesh pattern and the pitch T′ of the pixel of the display unit 40 and the angle θ1 as described above, thereby making it possible to decrease visibility of the electrode pattern 20 and prevent a Moire phenomenon of the image overlapped with the display unit 40. Here, Q indicates any one of R, G, and B of the pixels of the display unit 40.

Next, as shown in FIG. 8, an electrode pattern 20 according to a second preferred embodiment of the present invention may be formed so that a ratio of a pitch T2 of the mesh pattern to a pitch T′ of a pixel of the display unit 40 is 1:0.4 to 1:0.7. In this case, it is appropriate that an angle value θ2 of the mesh pattern is in the range of 32 to 38 degrees.

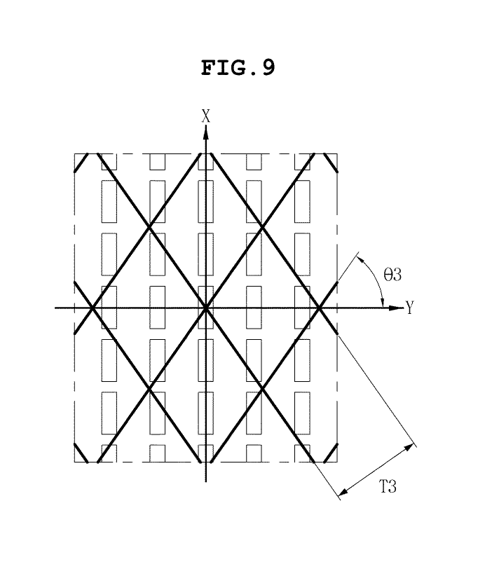

Next, as shown in FIG. 9, an electrode pattern 20 according to a third preferred embodiment of the present invention may be formed so that a ratio of a pitch T3 of the mesh pattern to a pitch T′ of a pixel of the display unit 40 is 1:0.4 to 1:0.7. In this case, it is appropriate that an angle value θ3 of the mesh pattern is in the range of 52 to 58 degrees.

The display unit 40 is a device coupled to a lower portion of a touch panel including the transparent substrate 10 and the electrode pattern 20 by an adhesive layer 30 and outputting an input value recognized by a touch of the touch panel. The adhesive layer 30 is formed at both ends of the display unit 40 to more effectively remove noise at the time of outputting the image. However, the adhesive layer may also be applied as a transparent adhesive layer on the entire surface. Here, the display unit 40 is not particularly limited, but may be any one of, for example, a liquid crystal display (LCD), a light emitting diode (LED), an organic light emitting diode (OLED), and a cathode ray tube (CRT). However, the CRT may be defined by a dot pitch value corresponding to the pitch T′ of the pixel. As described above, in the present invention, the mesh pattern is designed based on a correlation between the pitch T′ of the pixel of the display unit 40 and the pitch T of the mesh pattern forming the electrode pattern 20 in order to prevent the Moire phenomenon that may be generated in the image overlapped between the pixel pattern of the display unit 40 and the electrode pattern 20 of the touch panel correspondingly coupled to the upper surface of the display unit 40, thereby making it possible to decrease the visibility of the electrode pattern 20 and decrease the Moire phenomenon that may be generated in a relation with the display unit 40.

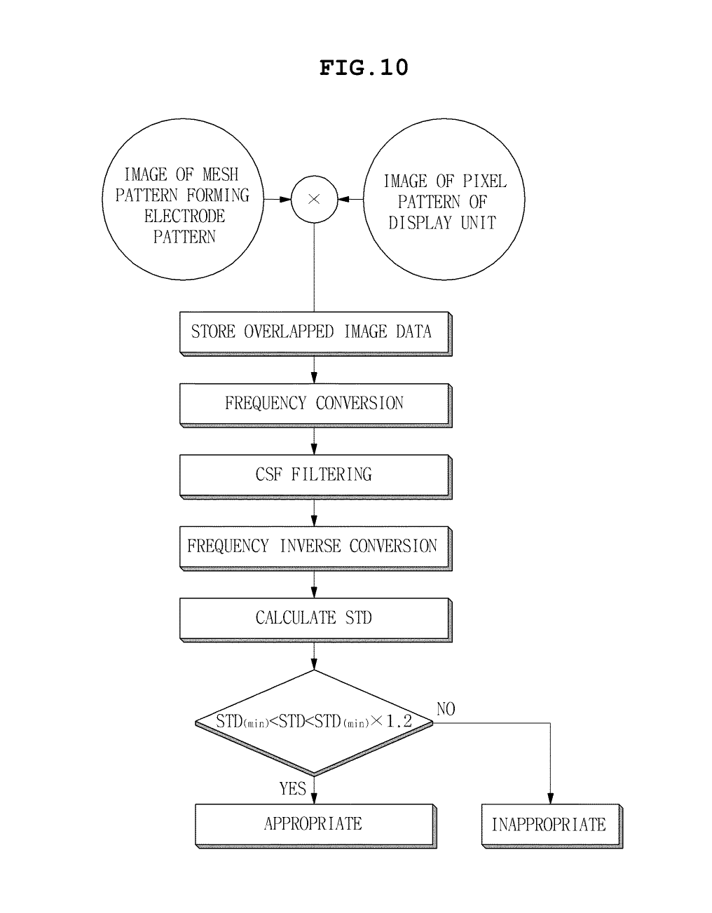

FIG. 10 is a flow chart showing a process of a method of evaluating visibility of an electrode pattern of the touch panel according to the preferred embodiment of the present invention.

The method of evaluating visibility of an electrode pattern of the touch panel according to the preferred embodiment of the present invention may include storing an image overlapped between a mesh shaped electrode pattern formed in the touch panel and a pixel pattern of a display unit 40, converting the stored image data into a frequency data, filtering the frequency data using a contrast sensitivity function (CSF), performing frequency-inverse-conversion on the filtered frequency data to generate image data, calculating a standard deviation (hereinafter, referred to as a ‘STD’) for the image data generated by the frequency-inverse-conversion, and judging whether or not the STD value satisfies the following Equation: STD(min)<STD<STD(min)×1.2 to adopt an electrode pattern formed in this region range.

Particularly, the present embodiment relates to the method of evaluating visibility for preventing the visibility and the Moire phenomenon of the image generated by overlapping between the mesh pattern of the electrode pattern of the touch panel and the pixel pattern of the display unit 40.

In the method of evaluating visibility of an electrode pattern of the touch panel according to the preferred embodiment of the present invention, a degree in which the mesh pattern forming the electrode pattern is recognized depending on human visible characteristics and whether or not the Moire by the electrode pattern and the pixel pattern of the display unit 40 is visible by the recognition of the mesh pattern is evaluated, thereby making it possible to define a correlation between the pitch T of the mesh pattern forming the electrode pattern and the pitch T′ of the pixel of the display unit 40 and the angle value of the mesh pattern.

The human visible characteristics are represented by a human recognition (identification) capability and a contrast shown at both sides of a graph and a spatial frequency shown at a lower portion of the graph, as shown in FIG. 6. The contrast indicates a difference in intensity between a tone of a predetermined portion of an image and a tone of another portion thereof. The meaning that the contrast of the image is that a difference between a bright degree and a dark degree of a specific image is larger as compared with a normal case. In the visibility of the electrode pattern, as shown in FIG. 6, as the contrast becomes large, that is, as the difference in intensity between the tones becomes more clear, the identification capability by the human visible characteristics increases in proportion to the contrast. That is, it may be appreciated that the identification capability for the contrast by the human visible characteristics may not be represented by a single function of the spatial frequency and is decreased at the highest frequency region and the lowest frequency region of the spatial frequency.

Here, a contrast sensitivity function (CSF) will be briefly described.

In a human field of view, a clear image, an unclear image, an image having a large brightness and darkness difference, and an image having a small brightness and darkness difference are mixed with one another. Eyesight indicates a general identification capability of human eyes for these several images. However, up to now, all eyesight test charts that have been generally used for an eyesight test have been manufactured so that a boundary is clear and a contrast difference is large.

Therefore, an identification capability of the human eyes for images of which a boundary is unclear and a brightness and darkness difference is small has been ignored. The identification capability of the human eyes for the images of which the boundary is unclear and the brightness and darkness difference is small is called contrast sensitivity. The CSF filter is a filter in which the human visible characteristics as described above are satisfactorily reflected. A function used in this CSF filter represents a spatial frequency of a lattice stimulus and a relation of a contrast required for perceiving a lattice. Measurement of CSF first starts from a sine wave lattice having a very low frequency (a wide bar). This lattice is invisible and is viewed as only a homogeneous gray field of view since a contrast of the lattice is very low. The contrast of the lattice is slightly increased and is increased until persons may barely view the bar. This contrast level is a threshold value at which the lattice may be viewed. In order to draw CSF, the threshold value is changed into contrast sensitivity by a relationship of contrast sensitivity=1/threshold value. The CSF value is a reciprocal number of the threshold value capable of recognizing a brightness difference. The larger the CSF value, the more easily the brightness change is recognized. Therefore, according to various studies on human eyesight, a brightness change is best recognized in the vicinity of about 6 to 8 [cyle per degree] and is not satisfactorily recognized as a frequency is increased. That is, although the human eyesight does not satisfactorily sense a change occurring at a relatively low frequency, it may satisfactorily sense a change occurring at a high frequency. The CSF filter as described above is used, thereby making it possible to know a degree of the visibility of the human for the mesh pattern forming the electrode pattern. In the present invention, the contrast sensitivity function (CSF) is used, thereby making it possible to judge a degree of the identification capability of the user for the mesh pattern. The contrast sensitivity function (CSF) may be any one CSF model of a Movshon CSF model, a Barten CSF model, and a Daly CSF model that are generally well-known, but is not particularly limited thereto.

The method of evaluating visibility of an electrode pattern according to the preferred embodiment of the present invention will be described in detail with reference to FIG. 8.

First, an image overlapped between the mesh-shaped electrode pattern formed in the touch panel and the pixel pattern of the display unit 40 is stored. An image in which the mesh pattern forming the electrode pattern and the pixel pattern overlapped with the mesh pattern are combined with each other is stored.

Next, the stored image is converted into a frequency form. Here, the conversion of the stored image into the frequency form may be performed using the Fourier transform Equation.

Next, the converted data in the frequency form are filtered using the contrast sensitivity function (CSF). Here,

CSF(ξ,η)=1.33 L\sqrt{ξ²+η²} exp(−0.49 L\sqrt{ξ²+η²})

where ξ and η mean spatial angular frequencies in X and Y axis direction in a two-dimension, respectively, and L means a distance of a field of view. Here, it means the case in which the mesh pattern is visible at a distance of a field of view of about 400 mm. The distance L of a filter of view may be adjusted at a relatively constant ratio depending on a magnitude of the pitch T.

Initial original image data are frequency-converted and are multiplied by the contrast sensitivity function (CSF), thereby making it possible to extract a range of the frequency in which the human visible characteristics may be recognized. A related equation will be described below.

Next, frequency-inverse-conversion is performed on the filtered frequency data to generate image data. In this case, the frequency-inverse-conversion may be performed by inverse Fourier transform.

Thereafter, a standard deviation (STD) for the image data generated by the frequency-inverse conversion may be calculated, and decrease characteristics of the Moire by coupling between the electrode pattern and the display unit 40 may be evaluated in a range in which STD(min)<STD<STD(min)×1.2 is satisfied.

Hereinafter, a process of inducing a related equation for calculating the standard deviation (STD) will be briefly described.

An appropriate meaning for an image coinciding with the human visible characteristics is that the image is in proportion to an image contrast. Although many definitions for this contrast are present, the most appropriate definition for the image may be root-mean-square (RMS).

$$RMS = \sqrt{\frac{1}{N - 1} {\sum }_{n}^{N} {( {I}_{n} - \overline{I} )}^{2}} \qquad ( Equation 1 )$$

Where N indicates the number of respective discrete points of the image, In indicates an intensity level of an n-th point of the image, and Ī in the above Equation 1 may be defined by the following Equation.

$$\overline{I} = \frac{1}{N} {\sum }_{n}^{N} {I}_{n} \qquad ( Equation 2 )$$

Ī in the above Equation 2 means intensity of the entire image of the mesh pattern. Here, a value defined as RMS may be defined as a standard deviation (STD) of the intensity distributed in the entire image region. The contrast sensitivity function (CSF) has a value of 0 at a point at which a frequency is 0. In this case, since a value of an image recognized by the human is also 0, it may be rewritten by the following Equation.

$$STD = RMS = \sqrt{\frac{1}{N - 1} {\sum }_{n}^{N} {I}_{n}^{2}} \qquad ( Equation 3 )$$

It may be appreciated that a value that may be recognized by the definition of the contrast as described above means the standard deviation (STD). That is, as the definition of the contrast, how well the patterns may be identified by the human may be recognized depending on the human visible characteristics through a value indicating by which difference the patterns are contrasted with respect to an average value according to a bright and dark degree of the image. The above Equation 3, which is a reference of the visibility, may be called the ‘visibility’.

The contrast sensitivity function (CSF) described above is to recognize a brightness difference. The meaning that a change in the brightness is well identified is that the human identification capability may be increased as shown in FIG. 3. The spatial frequency region coinciding with the human visible characteristics is filtered through the contrast sensitivity function (CSF) filtering to calculate the human identification capability of the mesh pattern forming the electrode pattern and the pixel pattern of the display unit 40 according to the present embodiment, thereby making it possible to evaluate the decrease characteristics of the visibility of the electrode pattern due to the Moire phenomenon, or the like.

Particularly, in the case of calculating the visibility of the Moire pattern in the present step, the definition of the above Equation 3 is used and the standard derivation (STD) for evaluating decrease characteristics of the Moire may be calculated and defined as follows.

First, it may be appreciated that the Moire pattern may be generated since the pixel pattern of the display unit 40 interferes with the electrode pattern. In order to evaluate the visibility of the Moire pattern, transmissivity of the electrode pattern rather than reflectivity of the electrode pattern should be calculated. This may be represented as follows. Where T may be defined as the pitch of the mesh pattern, and d may be defined as the width of the mesh pattern, which is a predetermined constant value in the range of about 5 μm. However, since a degree in which the electrode pattern is visible is generally in proportion to a value of the width, the value may be adjusted in an appropriate range by those skilled in the art. In addition, θ indicates an angle at which the mesh pattern is formed.

$${T}_{M} ( x , y ) = {s}_{1 M} ( x , y ) {s}_{2 M} ( x , y ) = {( \frac{T - d}{T} )}^{2} {\sum }_{n}^{ } {\sum }_{m}^{ } Sinc ( n \frac{T - d}{T} π ) Sinc ( m \frac{T - d}{T} π ) exp \{ - j \frac{2 π}{T} [ ( n - m ) x sin θ + ( n + m ) y cos θ ] \} \qquad ( Equation 4 )$$

The above Equation 4, which indicates a luminance of the pixel pattern of the display unit 40, may be resolved as follows using the Fourier series.

$${s}_{p} ( x , y ) = \frac{{D}_{X}}{{P}_{X}} \frac{{D}_{Y}}{{P}_{Y}} {\sum }_{n}^{ } {\sum }_{m}^{ } Sinc ( n \frac{{D}_{X}}{{P}_{X}} π ) Sinc ( m \frac{{D}_{Y}}{{P}_{Y}} π ) exp ( - j \frac{2 π}{{P}_{X}} nx - j \frac{2 π}{{P}_{Y}} my ) \qquad ( Equation 5 )$$

Where Px, Py, Dx, and Dy mean values of X and Y axes of the pitch T′ of the pixel and the width of the display unit 40, respectively. In order to analyze the Moire pattern, the above Equations 4 and 5 should be multiplied together. The entire image, that is, the input signal of the human visible system may be calculated as follows through the above-mentioned operation.

$$s ( x , y ) = {T}_{M} ( x , y ) {s}_{p} ( x , y ) = \frac{{D}_{X}}{{P}_{X}} \frac{{D}_{Y}}{{P}_{Y}} {( \frac{T - d}{T} )}^{2} {\sum }_{n}^{ } {\sum }_{m}^{ } {\sum }_{k}^{ } {\sum }_{q}^{ } \{ Sinc ( n \frac{T - d}{T} π ) Sinc ( m \frac{T - d}{T} π ) Sinc ( k \frac{{D}_{X}}{{P}_{X}} π ) Sinc ( q \frac{{D}_{Y}}{{P}_{Y}} π ) \times exp \{ - j 2 π [ \begin{matrix}\frac{( n - m ) sin θ}{T} + \\ \frac{k}{{P}_{X} }\end{matrix} ] x \} exp \{ - j 2 π [ \begin{matrix}\frac{( n + m ) cos θ}{T} + \\ \frac{q}{{P}_{Y}}\end{matrix} ] y \} \qquad ( Equation 6 )$$

In addition, when the above Equation 6 is filtered using the CSF, the following Equation is obtained.

$${s}_{OUT} ( x , y ) = {\sum }_{n}^{ } {\sum }_{m}^{ } {\sum }_{k}^{ } {\sum }_{q}^{ } {A}_{x} {A}_{y} {X}_{k} {Y}_{q} exp \{ - j ( {Ω}_{n , m}^{X} + \frac{2 π k}{{P}_{X}} ) x \} exp \{ - j ( {Ω}_{n , m}^{Y} + \frac{2 π q}{{P}_{Y}} ) y \} CSF \{ \sqrt{{( {Ω}_{n , m}^{X} + \frac{2 π k}{{P}_{X}} )}^{2} + {( {Ω}_{n , m}^{Y} + \frac{2 π q}{{P}_{Y}} )}^{2}} \} \qquad ( Equation 7 )$$

Where the respective coefficient values in the above Equation 7 are as follows.

$${A}_{n} = \frac{T - d}{T} Sinc ( n \frac{T - d}{T} π ) exp \{ - j π n \} ; \\ {X}_{k} = \frac{{D}_{X}}{{P}_{X}} Sinc ( k \frac{{D}_{X}}{{P}_{X}} π ) ; \\ {Y}_{q} = \frac{{D}_{Y}}{{P}_{Y}} Sinc ( q \frac{{D}_{Y}}{{P}_{Y}} π ) ; \qquad ( Equation 8 )$$

Here, when the above Equation 7 is substituted, transformed, and arranged, the following variance may be calculated.

$${σ}^{2} == {\sum }_{n 1}^{ } {\sum }_{m 1}^{ } {\sum }_{k 1}^{ } {\sum }_{q 1}^{ } {\sum }_{n 2}^{ } {\sum }_{m 2}^{ } {\sum }_{k 2}^{ } {\sum }_{q 2}^{ } {A}_{n 1} {A}_{m 1} {X}_{k 1} {Y}_{q 1} {A}_{n 2}^{*} {A}_{m 2}^{*} {X}_{k 2} {Y}_{q 2} \times CSF \{ \sqrt{\begin{matrix}{[ {Ω}_{n 1 , m 1}^{X} + \frac{2 π}{{P}_{X}} {k}_{1} ]}^{2} + \\ {[ {Ω}_{n 1 , m 1}^{Y} + \frac{2 π}{{P}_{Y}} {q}_{1} ]}^{2}\end{matrix}} \} CSF \{ \begin{matrix}{[ {Ω}_{n 2 , m 2}^{X} + \frac{2 π}{{P}_{X}} {k}_{2} ]}^{2} + \\ \sqrt{{[ {Ω}_{n 2 , m 2}^{Y} + \frac{2 π}{{P}_{Y}} {q}_{2} ]}^{2}}\end{matrix} \} \times {lim}_{L \to ∞} \{ Sinc [ \frac{L}{2} ( \begin{matrix}{Ω}_{n 1 , m 1}^{X} - {Ω}_{n 2 , m 2}^{X} + \\ \frac{2 π}{{P}_{X}} ( {k}_{1} - {k}_{2} )\end{matrix} ) ] Sinc [ \frac{L}{2} ( \begin{matrix}{Ω}_{n 1 , m 1}^{Y} - {Ω}_{n 2 , m 2}^{Y} + \\ \frac{2 π}{{P}_{Y}} ( q 1 - {q}_{2} )\end{matrix} ) ] \} \qquad ( Equation 9 )$$

When the above Equation 9 is more simply arranged, the final STD may be represented as follows.

$$( Equation 10 )$$

$$σ \sqrt{{\sum }_{n}^{ } {\sum }_{m}^{ } {\sum }_{k}^{ } {\sum }_{q}^{ } {\vert {A}_{n} \vert}^{2} {\vert {A}_{m} \vert}^{2} {\vert {X}_{k} \vert}^{2} {\vert {Y}_{q} \vert}^{2} {CSF}^{2} \{ \sqrt{\begin{matrix}[ {Ω}_{n , m}^{X} + \\ {\frac{2 π}{{P}_{X}} k ]}^{2} \\ [ {Ω}_{n , m}^{Y} + \\ {\frac{2 π}{{P}_{Y}} k ]}^{2}\end{matrix}} \}}$$

Next, whether or not the STD value derived from the finally defined above Equation 10 satisfies the following Equation: STD(min)<STD<STD(min)×1.2 may be judged to adopt the electrode pattern formed in this region range.

Where STD(min) means a minimum value of the STD value. Generally, for example, in the case of a quartic or more function, at least two minimum values may be considered. These respective minimum values may be defined as local minimum values, and the smallest value among the minimum values may be defined as a global minimum In the present invention, since STD may be represented by a multi-dimensional function having two variables of the pitch T and the angle θ as in the above Equation 5, it has a plurality of local minimum values. Therefore, STD(min), which is a minimum value of a value defined as STD in the present invention, may be defined as several local minimum values represented in the function and formed respectively.

Hereinabove, as definition of the contrast, an Equation of RMS has been defined. Since this equation may be defined as the same concept as that of the standard deviation, the visibility due to the generation of the Moire by the electrode pattern and the pixel pattern of the display unit 40 may be decreased in the range within 20% from the minimum value of the standard deviation for possible variables of all the mesh patterns calculated in the above Equation. Therefore, the combination of the mesh pattern and the pixel pattern of the display unit 40 and the angle value of the mesh pattern are defined in the range of the standard deviation, thereby making it possible to evaluate the entire visibility of the touch panel.

According to the preferred embodiment of the present invention, the Moire phenomenon that may be generated between the electrode pattern of the touch panel and the pixel pattern of the display unit coupled to the touch panel may be prevented.

In addition, the electrode pattern of the touch panel is formed in a mesh shape, and the pitch and the angle of the mesh pattern forming the electrode pattern for decreasing the Moire phenomenon and the visibility of the electrode pattern in a relationship with the pitch of the pixel of the display unit are calculated, thereby making it possible to design the display device including the touch panel having more improved visibility.

Further, the image contrast is performed on the image data finally generated by converting the image formed by overlapping between the electrode pattern of the touch panel and the pixel pattern of the display unit into the frequency, filtering the converted frequency using the contrast sensitivity function (CSF) appropriate for the human visible characteristics, and inversely converting the filtered frequency, thereby making it possible to detect and evaluate the visibility decrease characteristics of the electrode pattern and a region in which the generation of the Moire is decreased through the pitch and the angle of the mesh pattern and the correlation between the pitch of the mesh pattern and the pitch of the pixel of the display unit.

Furthermore, the visibility of the electrode pattern and the decrease of the Moire generation for the final image data generated by filtering the image generated by the overlapping between the electrode pattern of the touch panel and the pixel pattern of the display unit using the CSF may be defined as the root-means-square (RMS):

$$RMS = \sqrt{\frac{1}{N - 1} {\sum }_{n}^{N} {( {I}_{n} - \overline{I} )}^{2}} .$$

This RMS is also represented by the standard deviation (STD)

$$( σ \sqrt{{\sum }_{n}^{ } {\sum }_{m}^{ } {\sum }_{k}^{ } {\sum }_{q}^{ } {\vert {A}_{n} \vert}^{2} {\vert {A}_{m} \vert}^{2} {\vert {X}_{k} \vert}^{2} {\vert {Y}_{q} \vert}^{2} {CSF}^{2} \{ \sqrt{\begin{matrix}[ {Ω}_{n , m}^{X} + \\ {\frac{2 π}{{P}_{X}} k ]}^{2} \\ [ {Ω}_{n , m}^{Y} + \\ {\frac{2 π}{{P}_{Y}} k ]}^{2}\end{matrix}} \}} )$$

to derive the pitch and the angle of the mesh pattern formed in the range of 20% from a a value and the pitch of the pixel of the display unit, thereby making it possible to find the decrease in the visibility of the electrode pattern and the decrease characteristics of the Moire phenomenon by a uniform judging processor.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A display device including a touch panel, comprising:
a transparent substrate;
an electrode pattern formed as a mesh pattern on the transparent substrate; and
a display unit correspondingly coupled to the electrode pattern,
wherein a ratio of a pitch of the electrode pattern to a pitch of a pixel of the display unit is 1:0.3 to 1:0.5.

2. The display device including a touch panel as set forth in claim 1, wherein an angle value of the electrode pattern is in the range of 15 to 21 degrees.

3. The display device including a touch panel as set forth in claim 1, wherein the electrode pattern is made of copper (Cu), aluminum (Al), gold (Au), silver (Ag), titanium (Ti), palladium (Pd), chromium (Cr), nickel (Ni), or a combination thereof.

4. The display device including a touch panel as set forth in claim 1, wherein the display unit is any one of a liquid crystal display (LCD), a light emitting diode (LED), an organic light emitting diode (OLED), and a cathode ray tube (CRT).

5. A display device including a touch panel, comprising:
a transparent substrate;
an electrode pattern formed as a mesh pattern on the transparent substrate; and
a display unit correspondingly coupled to the electrode pattern,
wherein a ratio of a pitch of the electrode pattern to a pitch of a pixel of the display unit is 1:0.4 to 1:0.7.

6. The display device including a touch panel as set forth in claim 5, wherein an angle value of the electrode pattern is in the range of 32 to 38 degrees.

7. The display device including a touch panel as set forth in claim 5, wherein an angle value of the electrode pattern is in the range of 52 to 58 degrees.

8. The display device including a touch panel as set forth in claim 5, wherein the electrode pattern is made of copper (Cu), aluminum (Al), gold (Au), silver (Ag), titanium (Ti), palladium (Pd), chromium (Cr), nickel (Ni), or a combination thereof.

9. The display device including a touch panel as set forth in claim 5, wherein the display unit is any one of an LCD, an LED, an OLED, and a CRT.

10. A method of evaluating visibility of an electrode pattern of a touch panel, comprising:
storing an image overlapped between a mesh shaped electrode pattern formed in the touch panel and a pixel pattern of a display unit;
converting the stored image data into a frequency data;
filtering the frequency data using a contrast sensitivity function (CSF);
performing frequency-inverse-conversion on the filtered frequency data to generate image data;
calculating a standard deviation (STD) for the image data generated by the frequency-inverse-conversion; and
judging whether or not the STD value satisfies the following Equation: STD(min)<STD<STD(min)×1.2 to adopt an electrode pattern formed in this region range.

11. The method as set forth in claim 10, wherein the CSF is represented by the following Equation:
CSF(ξ,η)=1.33 L\sqrt{ξ²+η²} exp(−0.49 L\sqrt{ξ²+η²})
where ξ and η mean spatial angular frequencies in X and Y axis direction in a two-dimension, respectively, and L means a distance of a field of view.

12. The method as set forth in claim 10, wherein in the calculating of the STD, the STD is defined as a root-mean square (RMS) appearing in the filtered image data:
$$RMS = \sqrt{\frac{1}{N - 1} {\sum }_{n}^{N} {( {I}_{n} - \overline{I} )}^{2}} \qquad ( Equation 1 )$$
where N indicates the number of respective discrete points of the image, In indicates an intensity level of an n-th point of the image, and Ī in the above Equation 1 is defined by the following Equation:
$$\overline{I} = \frac{1}{N} {\sum }_{n}^{N} {I}_{n} \qquad ( Equation 2 )$$
the above Equation 2 means intensity of the entire image.

13. The method as set forth in claim 10, wherein the above Equation 1 for the STD is represented by the following Equation:
$$σ \sqrt{{\sum }_{n}^{ } {\sum }_{m}^{ } {\sum }_{k}^{ } {\sum }_{q}^{ } {\vert {A}_{n} \vert}^{2} {\vert {A}_{m} \vert}^{2} {\vert {X}_{k} \vert}^{2} {\vert {Y}_{q} \vert}^{2} {CSF}^{2} \{ \sqrt{\begin{matrix}[ {Ω}_{n , m}^{X} + \\ {\frac{2 π}{{P}_{X}} k ]}^{2} \\ [ {Ω}_{n , m}^{Y} + \\ {\frac{2 π}{{P}_{Y}} k ]}^{2}\end{matrix}} \}} .$$

14. The method as set forth in claim 10, wherein the converting of the stored image data into the frequency data and the performing of the frequency-inverse-conversion on the filtered frequency data to generate the image data are performed by the Fourier transform and the inverse Fourier transform, respectively.
